(19) United States
(12) Patent Application Publication
(10) Pub. No.: US 2005/0263102 A1
(43) Pub. Date: Dec. 1, 2005

(54) Wearable horizontally oriented multi-positional pet carrier

(76) Inventors: Suzanne E. Sherman, Nokomis, FL (US); Hedy P. Grant, New Milford, NJ (US)

Correspondence Address: Suzanne E. Sherman, 2330 Harrier Way, Nokomis, FL, 34275, US

(21) Appl. No.: 11/121,235

(22) Filed: May 3, 2005

Related U.S. Application Data
(60) Provisional application No. 60/568,799, filed on May 7, 2004.

(51) Int. Cl. A01K 15/00

(52) U.S. Cl. 119/792

(57) ABSTRACT

A wearable, multi-positional apparatus and method for transporting an animal horizontally in an adjustable, body-conforming apparatus worn about the human torso. The carrier consists of a convex shaped main body panel bound at it perimeter by flexible, semi-rigid binding material. The body panel passes beneath and is drawn up around the animal that is secured under its hindquarters and beneath the chest area in front of the forelegs away from the esophageal area with the pet in a natural horizontal level orientation. The carrier provides for leg openings that are cushioned and mold around the animal's legs to produce a custom fit. The animal within the apparatus can be carried by hand via tote style handles, and has a multi-positional strap system that permits the carrier to be draped over the shoulder, around a person's waist, across the human chest, or converted to a leash.

### CROSS-REFERENCE TO RELATED APPLICATIONS

This application claims the benefit of provisional patent application Titled: Non-Enclosed Hands-Free Pet Carry System, filed on May 7, 2004, Ser. Nr. 60/568,799, by the present inventors.

### FEDERALLY SPONSORED RESEARCH

Not Applicable

### SEQUENCE LISTING OR PROGRAM

Not Applicable

### BACKGROUND OF INVENTION

1. Field Of Invention:

This invention generally relates to carriers for pets, specifically a wearable multi- positional apparatus and method for transporting animals, of a size and weight that can be carried comfortably by a human, in a substantially horizontal level orientation.

2. Prior Art

Multi-tasking has become an aspect of our modern life and individuals now, as never before, tend more and more to want their pet with them while performing other activities. The human may wish to shop or dine with their pet; carry groceries, a briefcase or a container of coffee while accompanied by their pet; power walk or stroll through the city or hike on a mountain trail. This can mean having their pet with them when attempting to get in and out of a vehicle or public transit, or communicate with cell phone or personal digital assistant in a variety of locales from beach to boat to boulevard. The carrier should not be awkward to wear. It should be readily adjustable and convertible. It should allow the person to interact with the pet while in transport. It should allow the multi-tasking person to make changes “on-the-run” in the way the carrier is being worn on the person.

This must be done, however, without causing physical discomfort to the human handler or their pet. The handler must be able to keep the weight of the pet near their body to lessen the strain the pet's weight can produce and be sufficiently adjustable and mutli-positional. The carrier should also provide for the comfort of the pet in a contoured, secure, natural horizontal position that would neutralize spinal stress of the pet and dramatically decrease the possibility of any coughing, choking or asphyxiation hazards where the placement of certain carriers about the pet's body is close to the delicate esophageal areas of smaller animal breeds.

It is well known that in the past, the variety of ways to transport small animals essentially consisted of two (2) main types of carriers: those consisting of totally enclosed fixed shaped carriers; and non-fixed shape, semi-enclosed styles. The proposed purpose of these carriers was to permit a person to assist the animal in walking or to transport the pet of suitable weight, while offering some form of restraint and alleged comfort for the pet and handler. Each of the prior carrier devices and methods have various and well-known disadvantages. For example:
(a) Typical fixed shaped satchel style enclosures are shown in U.S. Pat. No. 5,170,745 to Burdette, Jr. (1992) and U.S. Pat. D442,748 S to Farrugia (2001), of luggage style carriers with short handles for transporting the pet. These enclosed type carriers do not suit multi-tasking people who require an ability to interact with the pet; avoid harmful issues of excessive heat build-up; reduce anxiety experienced by the pet being enclosed and separated from the owner; and an ability by the owner to observe if the pet is experiencing any distress. Further, the enclosed fixed shape carrier would have weight and dimension issues that would most likely hinder the owner from transporting the pet for long distances and/or extended periods of time and in rough terrain.

(b) U.S. Pat. No. 5,277,148 to Rossignol (1994) shows a combination of a fixed shape enclosure with a backpack form of support. Such a carrier is exceedingly unwieldy and would not permit the handler to engage in a strenuous activity or move easily in crowded public places. Other backpack style carriers are shown in U.S. Pat. No. 5,419,281 to Williams (1995), and U.S. Pat. No. 6,701,871 B1 to Johnson (2004), and have the same disadvantages of any fixed shaped enclosed carrier.
(c) An absence of maneuverability and destination choices for active, mobile pet owner is demonstrated in U.S. Pat. D475,660 S to Licciardello (2003), where a carriage or stroller type device also presents the potential for the pet to experience anxiety, heat build up issues, and limits the activities and locales that can be shared with the handler.
(d) U.S. Pat. No. 6,216,636 B1 to Butchko (2001), U.S. Pat. No. 6,631,697 B1 to Solze (2003), and U.S. Pat. No. 6,694,921 B2 to Emerick (2004) each show the simplest sling style of carriers comprised of an apparatus made of various material that is slung beneath a dog or pet with some type of handle that the human can pull up on to carry or assist the pet in walking. None of these make for easy, stable comfortable carrying of the pet in an off-the-ground situation and lack stability in construction and use.
(e) U.S. Pat. No. 4,644,902 to Doyle (1987) illustrates a sling or pouch type carrier with holes for each leg of the pet to pass through and straps, joined by a buckle, that serve as a handle. Such a carrier is not, however, readily multi-positional and the rear openings to receive the pet's hind legs are elongated which may allow the pet to retract its hindquarters into the body panel creating a potentially dangerous situation where the pet can shift within and/or become dislodged from the carrier.
(f) U.S. Pat. D290,178 to Nissen (1987) also shows the placing of the pet's legs into openings that form pockets that severely restrict the leg movement and uses a permanently fixed shoulder strap. This device, however, is essentially not multi- positional and does not contribute to the comfort of the pet.
(g) An additional and potentially harmful consequence to the different methods of transporting a pet is produced by placing the pet in an unnatural vertical orientation thereby putting unneeded and potentially harmful stress on the animal's spine. This potentially harmful positioning is shown in the satchel, pouch and handbag type carriers of U.S. Pat. No. 5,176,102 to Tracy (1993); U.S. Pat. D344,372 to Maddix (1994); U.S. Pat. No. 5,490,478 to Cole (1996); and U.S. Pat. No. 6,394,039 B1 to Grauer (2002). These vertical carry configurations contribute to the physical discomfort the pet would experience when being carried for any period of time and conceivably present both breathing and spinal compression problems for the pet.
(h) The patent issued to Manuel, U.S. Pat. No. 5,894,817 (1999), shows a carrier with a center bottom panel from which side panels extend and form openings for the insertion of the pet's legs. This device, however, is designed in part to carry the animal in an “ . . . upright or standing position”, with the multi-functional aspect of the device realized by the use of carrying straps that are attached and/or made adjustable by the use of Velcro type hook and loop strips which would be susceptible to slippage or disengagement when bearing the weight of the pet.
(i) It is well known that pets of smaller breeds have weak esophageal airways and owners are advised to avoid using collars or leashes attached to collars to avoid choking the pet and/or crushing its airways; thus the recommendation that only harnesses be used to restrain smaller breeds. U.S. Pat. No. 6,802,282 B2, to Muckleroy (2004), shows a mutli-functional carry device that can expose a small breed size pet to this potential danger.

The device in Muckleroy can contact the pet at that very delicate neck location where the “joinders” for the handle/straps are close to the pet's throat opening at the front of the “bone-shaped” panels and any pulling on straps will tend to further close the opening. Indeed, the bone-shaped panel is specifically designed to accept the animal's “throat” thus creating a recipe for disaster of possible choking, crushing of the windpipe, strangulation, and/or asphyxiation when the handle/straps are pulled together and/or the pet's weight bears down on the panels.

### BACKGROUND OF INVENTION—OBJECTS AND ADVANTAGES

The general object of this invention is to provide for an apparatus and method of transporting small pets off ground in such a manner as to enable the animal to be transported and supported horizontally in a more level, safe, comfortable manner within an open-air, lightweight body-conforming apparatus. The carrier apparatus could be worn about the human torso as one would wear an adjustable and/or removable shoulder bag or purse, draped over the shoulder, around the circumference of one's waist, transverse the human body from the shoulder to opposite hip, or carried by hand to provide comfort and versatility for the human handler.

Accordingly, several objects and advantages of the subject invention are:
(a) to provide for a pet carrier apparatus that would support the animal in a more natural horizontal supine level orientation to neutralize spinal stress that can build up over long periods of time within a carrier.
(b) to provide for a wearable, apparel-like lightweight, comfortable, safe carrier device with a flat body panel of convex shape that positions the forward weight of the pet at, on, or near the chest area to avoid a choking, asphyxiation or strangling hazard posed by pressure on the esophageal area of a smaller breed animal.
(c) to provide for a pet carrier that permits the animal to be supported by a flexible semi-rigid binding material such that the pet's chest area is encircled in front of the forelegs and directly under its hindquarters, thereby keeping the pet in a horizontal level position relative to the ground and provide it's spine with stability, and its esophageal airway free from constriction.
(d) to provide a carrier that would reduce the likelihood of the pet-occupant becoming dislodged from the apparatus even if the main body panel material should stretch, loosen or disengage, such that the pet would continue to be securely retained and restrained safely in the device.
(e) to provide for a pet carrier with cushioned leg openings in a one-piece convex shaped main body panel to cushion and mold around the pet's fore and hind legs after their placement in the carrier.
(f) to provide for a carrier that affords the pet a stable, comfortable, secure device for carrying the pet off ground by means of tote style handles and with an adjustable strap system that is multi-positional.
(g) to provide for a carrier with a strap system that permits the adjustment of the horizontal elevation of the pet-occupant relative to the ground and/or height and girth of the handler.
(h) to provide for a carrier that utilizes a releasable securement means to provide for ease of attachment and disengagement from the carrier while the handler is in motion or stationary.
(i) to provide for a carrier apparatus that securely locks the pet into the carrier should, for any reason, the panel that is around the body of the pet become disengaged or stretched.
(j) to provide for a wearable, open-air, apparel-like pet carrier apparatus that permits the handler to interact with and observe the pet-occupant, that reduces pet anxiety and agitation, that avoids excessive heat buildup that can present a health risk for the pet, and contours to the body of the animal and human.

(k) to provide for a carrier that permits the handler to use two hands to shop, dine, conduct business, or carry groceries while their pet is safely secured at the human's side or waist.
(l) to provide for a carrier that allows the human to undertake long walks or daily exercise routine they were previously prevented from doing with small, short- legged pets that are unable to attain sufficient speed or duration of time to satisfy the human walker.
(m) to provide for a lightweight, body-conforming pet carrier that is multi-positional and readily maneuverable to be worn by a handler when participating in different physical activities and settings regardless of the type of terrain that may be encountered.

Therefore, not until this apparatus and method has the pet and human handler been afforded the versatility and adaptability of a multi-positional, wearable carrier contoured to the handler's body in an open-air manner formed by a convex shaped body panel made of flexible materials, with the comfort of a cushioned leg aperture/openings. Nor have past methods provided the safety, support, and durability produced by a convex shaped main body panel encased at its perimeter by semi-rigid binding material that are substantially parallel to one another at there opposite sides to horizontally support and protect the pet's spine in a level position and safely secure the animal regardless of its weight and to lessen any health risks by moving the pet's weight away from the esophageal area.

Further objects and advantages will become apparent from a consideration of the ensuing description and drawings.

### SUMMARY OF INVENTION

In accordance with the present invention an apparatus and method of transporting an animal, of a size and weight that can be comfortably carried by a person, in a safe, horizontal level orientation, that is comfortable, multi-positional, open-air, lightweight, body-conforming, and apparel-like, with the animal retained within a convex shaped body panel that has cushioned leg openings and an adjustable strap system that can be worn about the human torso.

### DRAWINGS—FIGURES

FIG. 1 is a perspective view of apparatus in closed carrying position with simulated pet occupant.

FIG. 2 is a side view of exterior body panel in closed carrying position without pet occupant.

FIG. 3 is an exterior aspect of carrier body panel in open, non-carrying position showing convex shape of panel, fixed tote style handles and hook and loop fastening strips.

FIG. 4 is a perspective view of carrier device showing hook and loop fastening strips.

FIG. 5 is a detailed view of detachable metal swivel hook and D-ring system.

FIG. 6 is a pictorial of the several methods for wearing and/or utilizing the carrier device.

FIG. 7 is an exterior aspect of carrier body panel in open, non-carrying position showing alternative horizontal binding support material.

FIG. 8 is a perspective view of carrier device showing alternative hook and loop system with extended body panel smoothing flap.

FIG. 9 shows two (2) alternative configurations for a multi-positional strap system coupling band and methods of its use.

FIG. 10 is an exterior aspect of carrier body panel showing alternative removable panel section fabric opening to facilitate pet urination.

FIG. 11 is an exterior aspect of carrier body panel showing alternative inclusion of incontinent pad.

### DRAWINGS—REFERENCE NUMERALS

10 . . . main convex shaped body panel
12 . . . leg opening (4)
14 . . . cushioning material at leg openings
16 . . . hook and loop releasable fastening system
16a . . . . hook strip of fastener system
16b . . . . loop strip of fastener system
18 . . . affixed tote style handles (2)
20 . . . elongated adjustable straps (2)
22 . . . selectively adjusting tri-glide slides (2)
24 . . . releasable swivel hooks (4)
26 . . . D-ring connectors (4)
28 . . . semi-rigid binding material
29 . . . horizontal support webbing
30 . . . extension of body panel material for smoothing flap
32 . . . multi-positional strap coupling band configuration 1
34 . . . multi-positional strap coupling band configuration 2
36 . . . removable body panel section opening
38 . . . material covering for removable body panel section opening
40 . . . incontinent pad

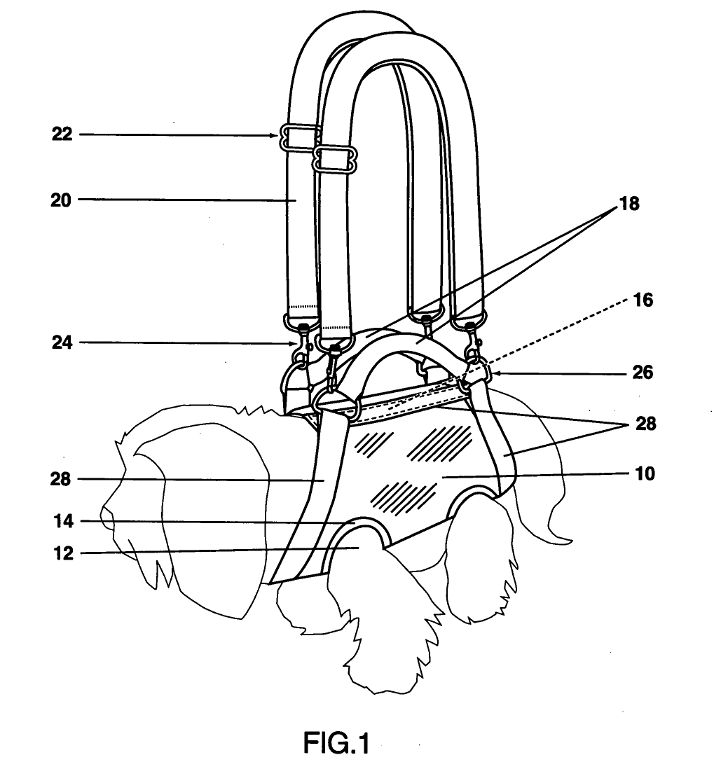

### DETAILED DESCRIPTION—PREFERRED EMBODIMENT AND FEATURES—FIGS. 1 TO 6

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

FIG. 1 shows a perspective view of the carrier in a closed position with a simulated animal occupant. The main body panel 10 is substantially convex in shape with two sides substantially parallel to one another of greater length than the other two adjacent sides and can be made of different flexible materials and in different sizes to accommodate the smallest of pet breeds and grading upward in increments to accommodate occupants up to a size and weight that can comfortably be carried by a person. By way of example the body panel can be made of many materials selected from a group consisting of flexible, sturdy cloth fabrics, nylon, vinyl, leather, denim, velvet, synthetic or natural fibers, organza, lace, furs whether real or faux, or other similarly constituted materials. The body panel is drawn up around the animal from below with the legs extending through the four leg openings. The body panel has a releasable closure means along its top edge and a means for attaching handles and carry straps.

The interior aspect of body panel 10 is encased at its perimeter by strips of a semi-rigid, flat, non-round, binding material 28 of predetermined length, to provide structure, strength and durability, and to seal and finish all edges. It is presently preferred that the binding material 28 consist of polypropylene of approximately one-(1) inch in width. However, the binding material can be made of any number of different flexible, semi-rigid, sturdy materials such as nylon, leather, cotton, synthetic or natural fiber and alternatively of wider and narrower width and thickness.

A length of binding material 28 is stitched to body panel 10 along the superior portion of the perimeter of each shorter edge side of the body panel. Then a length of binding 28 is stitched for safety to the inferior side of the perimeter of each shorter edge side of body panel 10 with the body panel sandwiched between the two (2) lengths of binding material 28. A length of binding 28 is then stitched to each of the inferior longer edge sides of body panel 10 along its perimeter with a continuous additional length extending over the panel and on to the superior perimeter of body panel 10. A second length of binding 28 is then stitched to each of the superior longer edge sides of the body panel 10 with the end of the binding material 28 inserted into D-rings 26 or other similarly configured connecting means. The binding material 28 on the superior side of panel 10 is then tucked under itself enclosing the D-ring then it, panel 10, and the sections of binding 28 enclosing the body panel 10, are stitched together leaving no raw edges. Although the stitching method is preferred, any comparable fastening method, such as adhesives, heat fusing, clamping or stapling may be employed so long as it is able to adequately and safely not stretch or separate and bear the weight of the animal in the carrier.

Body panel 10 includes four (4) equally spaced leg openings 12 that are surrounded at the interior aspect of the opening by the application of soft, flexible cushioning material 14 both inferior and superior to panel 10. It is presently preferred that the cushioning material consist of bias tape, but can be made of any other comparably soft, flexible fabric, synthetic or natural fiber, furs whether real or faux, or other similarly constituted materials.

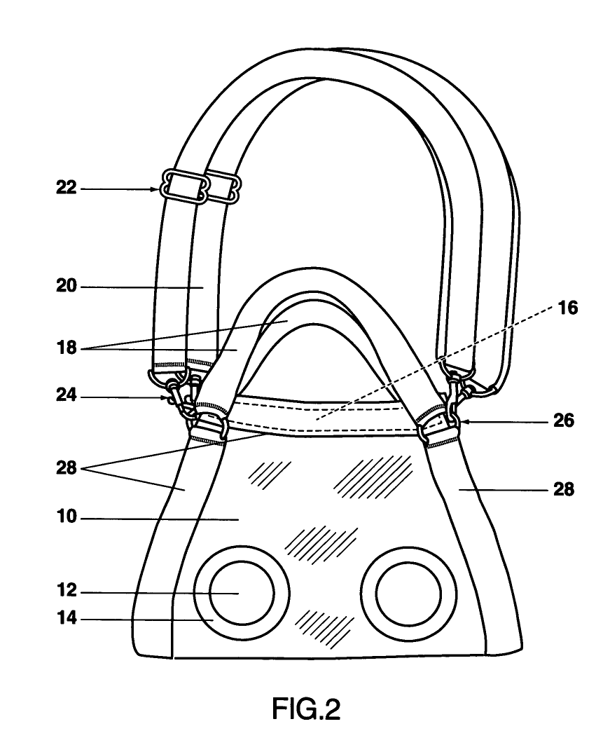

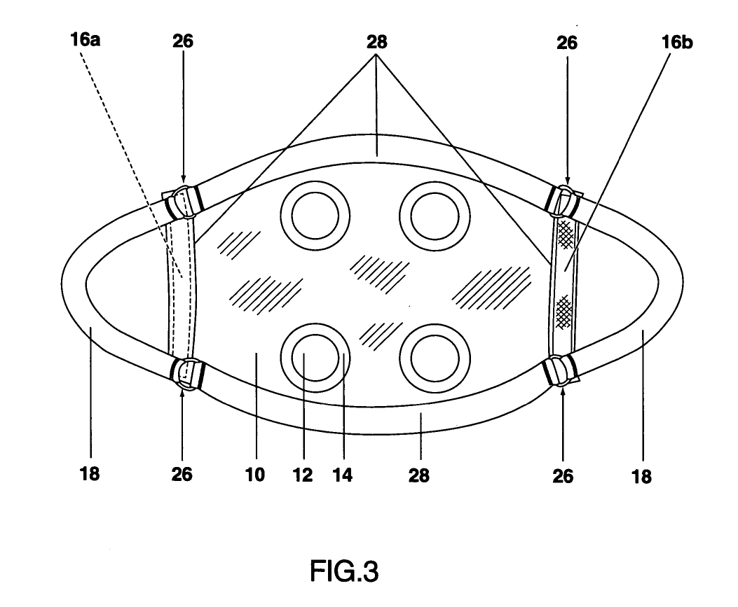

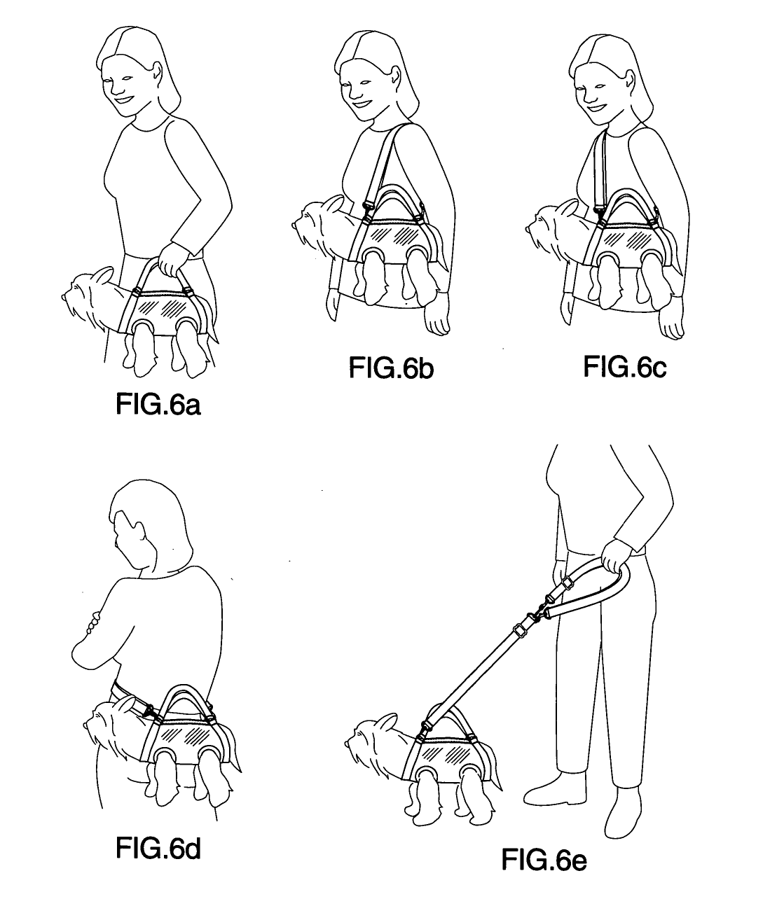

The flexible cushioning material 14, as shown in FIGS. 2 and 3, is applied to the circumference of leg opening 12 in such a way as to allow a portion of the material 14 to extend not less than approximately one-quarter inch (¼″) in towards the center-point of the leg opening 12. The edges of the cushioning material are tucked under themselves and stitched so as to have no raw edges. This flexible material then serves to further cushion the occupant's legs and custom fit each individual pet at the leg opening 12 by molding itself around the occupant's legs as depicted in FIGS. 6a to 6e. The diameter of the leg openings 12 are also increased incrementally when fashioning carriers for larger pet breeds with the spacing between the openings being expanded in a like incremental manner.

As shown in FIG. 3 the panel 10 is convex in shape along each of its two longer edge sides with the width of the panel at mid-line being approximately one-third (⅓) longer than the length of its shorter edge side. The ratio between the length of said longer edge side of the body panel in relation to the shorter edge side expands incrementally with the maximum length of the longer edge sides at approximately twice (2×) the length of the shorter edge sides; thus the carrier can retain breeds of different sizes. Furthermore, to accommodate larger breeds that typically have more girth from the mid-body forward than they do from their waist to hindquarters, one longer edge side of panel 10 has a predetermined length that is greater than the opposite longer edge side with both shorter edge sides remaining equal in length to each other. Thus, the opening for the head and chest of the animal at the front portion of the carrier will be larger the opening for the hindquarters at the rear of the carrier.

As seen in FIG. 3, a flexible, flat, sturdy material for tote style handles 18 is inserted through a D-ring 26, tucked into itself and then stitched for safety back onto itself leaving no raw edge. The other end of the tote style handle 18 is similarly joined by stitching to a D-ring 26 at the opposite end of the same shorter edge side of panel 10. The same assembly process is repeated with the other tote style handle 18 with D-rings 26 located on the opposite shorter edge side of panel 10. Once again here as with all other references to stitching, this is a preferred method but any comparable fastening method as noted above may be used.

In the preferred method, the tote handle material is made of the same material used for the binding 28 or any other flat, flexible, sturdy material as noted above. In addition, the stitching method is preferred but, as noted above, any suitable fastening method may be employed so long as it is able to adequately and safely not stretch or separate and bear the weight of the animal while in the carrier.

FIG. 3 shows the ends of the binding material 28 inserted into each of the four (4) D-rings 26, with the binding strip 28 tucked under itself, then stitched for safety back onto itself enclosing its end and the straight bar portion of the D-ring 26. It is then stitched down on to binding 28 that came from the inferior part of panel 10 to the superior longer edge side and stitched through it and through body panel 10 and through the binding 28 that is on the inferior portion of body panel 10. Again, stitching for securing the binding material 28, D-ring 26 and panel 10 is a preferred method but other means may be employed with the concerns as noted above.

Thus, a pair of binding material strips 28, wrap around the pet's body in an arcing manner opposite to one another forming a framing configuration for support of the pet-occupant at the lower chest area in front of the forelegs and under the hindquarters.

FIG. 2, shows strips of sturdy flat flexible material 28, formed into straps 20 to adjust for different activities and handler body types. The preferred material and width for the straps 20 is the same as the binding material 28 but can consist of any other comparable flexible, sturdy material, including metal chain, and alternatively of wider and narrower width and thickness.

Each of the two adjustable carry straps 20 is assembled by inserting one 3-bar tri-glide slide 22, onto one end of strap 20 such that the strap is inserted facing up through one opening of slide 22 and then inserted, facing down, in the opposite direction into the other of the two (2) openings of the slide 22. The end of strap 20 is then inserted though a swivel hook 24 looping around its flat bar. Then the end of the strap is inserted upward again into slide 22, underneath the portion of strap 20 that was initially inserted into slide 22, looped around the bar of the slide 22 and then pulled back to rejoin itself inferior to the bar of the slide 22, where it is then tucked under and stitched to itself leaving no raw edge. The same strap assembly is repeated with the second carry strap also with stitching as a preferred method to attach the strap to itself.

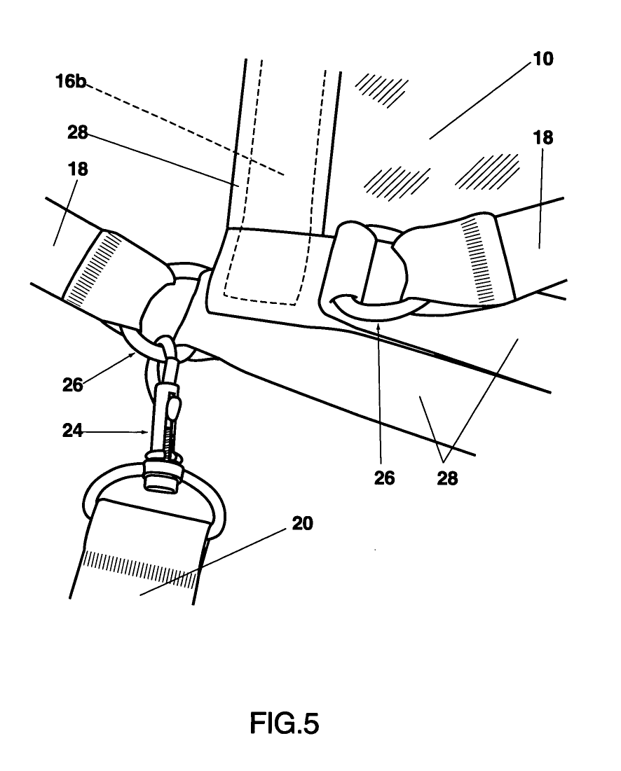

The other end of strap 20 as shown in FIG. 2, is passed through a swivel hook 24 looping around its flat bar, with strap 20 then tucked in and joined to itself by stitching again leaving no raw edge. The same strap assembly process is repeated with the second strap 20. Care is taken to assure that both ends of strap 20 are stitched to itself on the same/wrong side of the strap 20 as shown in FIG. 2 and FIG. 5. Although a swivel hook attached to a D-ring is a preferred method for securing the straps 20 to body panel 10, any other comparable releasable and engaging connecting means can be used.

The straps 20 can be used together or one at a time at the human's option as dictated by comfort and stability. When used in tandem, the straps can be affixed to corresponding D-rings, or in a preferred mode attached to opposing D-rings to safely “lock” the carrier body panel 10 closed around the pet-occupant; thus ensuring that the animal is safely retained within the carrier even if the hook and loop fastening strips become dislodged or separated.

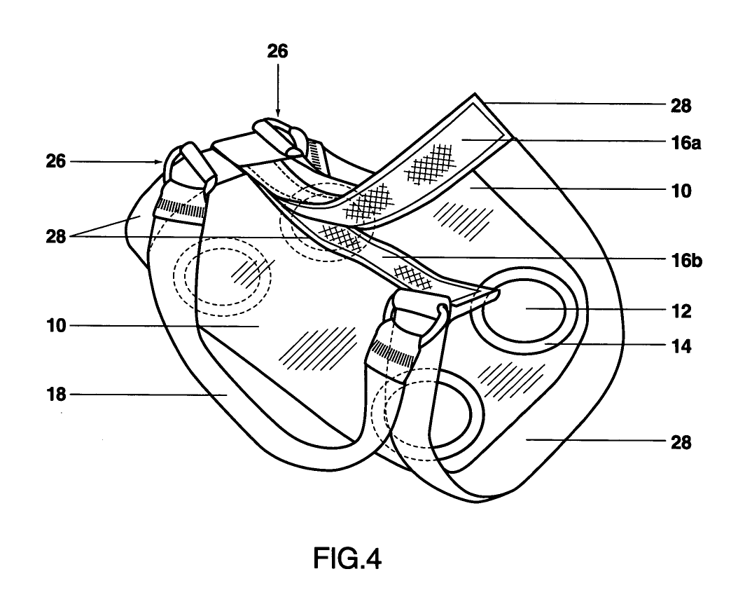

As shown in FIG. 4, the hook strip 16a of the hook and loop fastening system 16 is affixed to the length of a shorter edge side of panel 10 facing the interior of body panel 10 with the panel 10 fabric sandwiched between hook strip 16a and binding 28 such that there are no raw edges of panel. The loop strip of 16b is affixed in a strip the length of the opposite shorter edge side of panel 10 in a similar assembly process but with the loop portion in the direction of the exterior portion of the body panel. FIG. 3 also shows the hook side of 16a attached to the shorter edge side of panel 10, with the loop side 16b affixed to the opposite shorter edge of panel 10.

### Operation—Preferred Embodiment

As shown in FIGS. 1 and 6a, the animal occupant is placed on main panel 10 with its legs inserted in openings 12 with the occupant's center bodyline at a 90° angle to the longer edge sides of body panel 10 and in line with the hook and loop strips 16. The panel 10 is then drawn up around the occupant's body and secured by means of the hook and loop strips 16 that are affixed on the underside of one shorter edge binding 28 and on the superior side of the opposite shorter edge binding 28, thus forming a tubular, double open-ended pouch that can be carried by means of the tote style handles 18.

The forward binding material 28 passes under the pet's lower chest area and neutralizes any choking hazard by avoiding the neck/esophageal area with the rearward located binding material 28 passing under the pet's hindquarters. In sizes of the carrier for the larger breeds and body types, the hindquarter of the pet-occupant will be placed in the rearward end of the panel 10 with an opening that is smaller than the forward opening in order to accommodate a progressively greater girth in the chest portion of the occupant in comparison to the more diminutive waist circumference of the animal.

FIGS. 6a to 6e illustrate some of the several options for wearing and utilizing the carrier by a typical human handler. FIG. 6a shows the hand tote carry method without the use of straps 20. Shown in FIG. 6b is the standard over-the-shoulder use of the carrier with straps 20, while FIG. 6c demonstrates the cross-chest carry method. The around the waist configuration is shown in FIG. 6d, with the handler able to position the carrier on either hip, front waist or the small of the back depending upon the user's personal preference or the activity in which the handler may be engaged. The straps 20 can be further adjusted in horizontal elevation height to allow for the handler's height relative to the ground, or girth, body style and personal carriage preference. Finally, FIG. 6e demonstrates the use of straps 20 as a leash.

As illustrated by FIG. 6b, once the occupant is in the carrier, the straps 20 can be draped over the human's shoulder, adjusting slides 22 for a comfortable fit when transporting the occupant in a horizontal level position with the carrier's elevation relative to the human varying from the user's hip to armpit elevations. Further, as illustrated by FIG. 6c, once the occupant is in the carrier, the straps 20 can be draped across the handler's chest from a shoulder to opposite hip in a cross-body fashion after adjusting the slides 22 for a custom fit.

Furthermore, when the occupant is in the carrier, straps 20 can be attached to both of the two (2) D-rings 26 that are the closest to each other when the carrier is in a closed position. Both swivel hooks 24 then enclose both D-Rings 26 to “lock” the carrier closed. As illustrated by FIG. 6d, the straps 20 can be wrapped around the occupant's waist and joined by swivel hooks 24 to the D-rings 26 employing the same “locking” method noted above of both swivel hooks into both D-rings. The human carrier then adjusts the tri-glide slides 22 for a custom fit about the human waist.

FIG. 6e illustrates the transformation of the straps 20 into a leash allowing the pet- occupant to place its feet on the ground. The straps 20 are disconnected from the carrier but for one strap that is connected by the swivel hook 24 to and enclosing both forward D-rings 26 that are located between the shoulders of the occupant, essentially locking the carrier closed. The second strap 20 is connected to the free end of the first strap 20 by swivel hooks 24 and may be kept extended for maximum length or looped around and fastened to itself as a handhold. The slides 22 are then used to further adjust for the desired length of the leash.

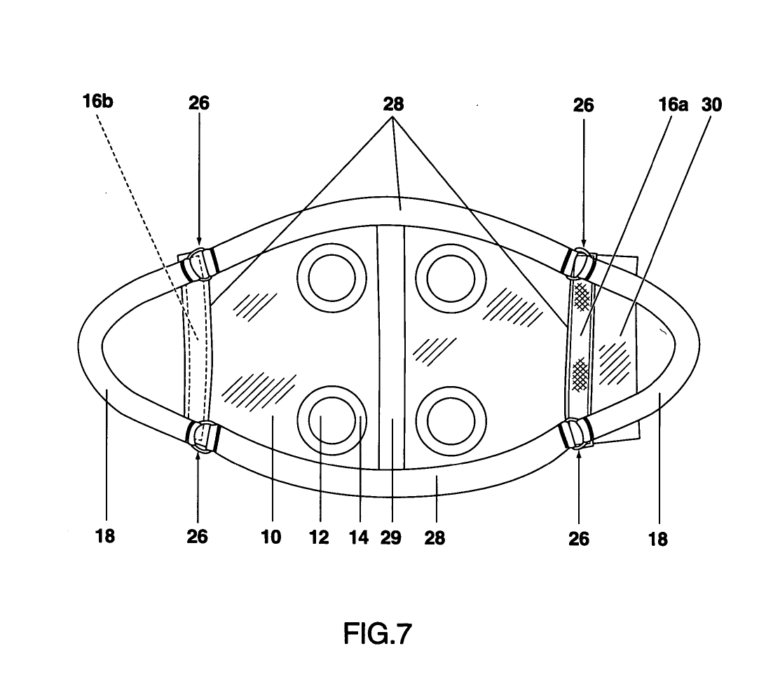

### Additional/Alternative Embodiments—FIGS. 7 to 11

FIG. 7—Additional Support Material Embodiment

As illustrated in FIG. 7 an alternative method that can be employed with heavier pet breeds is the inclusion of an additional strip of flexible semi-rigid binding material in the body panel 10. This H-bartype of frame construction is comprised of a sturdy flexible binding material 29 that runs under the pet's abdomen parallel to the spine line to form the horizontal bar 29 of the H; the two vertical bars of the H being the longer edge binding materials 28 that pass beneath the pet's chest in front of its fore legs and under its hindquarters arcing over the top of the animal's spine.

This type of construction supports the carriage of a heavier animal breed in a manner protective of its spine and provides a safety guarantee that the device will not permit the animal occupant to be dislodged from the carrier even if the main body panel 10 material should stretch, loosen, or dislodge: the horizontal H-bar 29 and parallel-bar binding material 28 supports the entire carrier and would continue to securely retain and restrain the pet-occupant safely within the carrier.

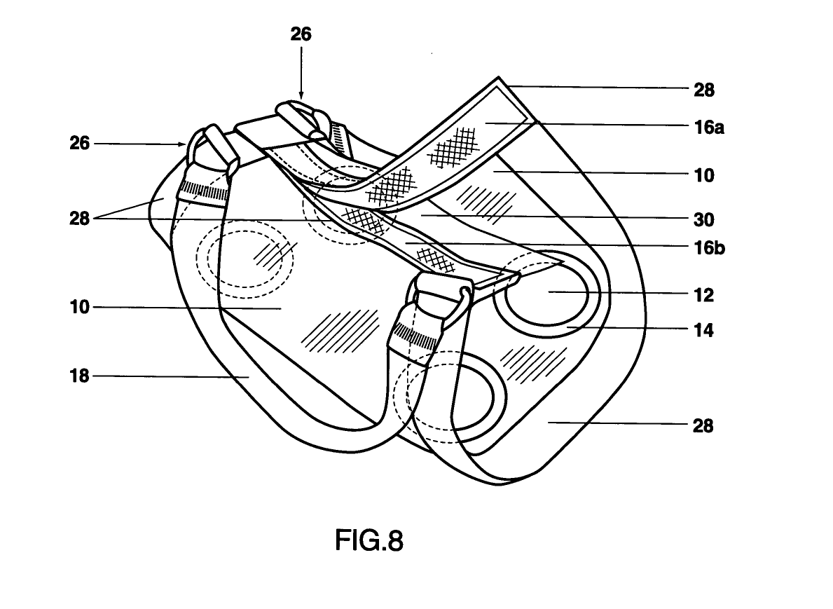

FIG. 8 Additional Smoothing Flap Embodiment

As seen in FIG. 8 an alternative embodiment employs a smoothing flap 30 to prevent the tangling of a longhaired pet-occupant with the hook and loop strips 16 during insertion of the animal into the carrier. In this embodiment the body panel 10 would not end at the loop strip 16b on the shorter edge side of panel 10, but rather would continue for a distance before terminating thereby forming the extension 30. This extension would have no raw edges as it would be tucked under at all edges and fastened to itself by stitching or any one of several comparable fastening methods. This construct would allow the extension 30 to flatten and protect the long hair of the pet, keeping it away from the hook and loop juncture.

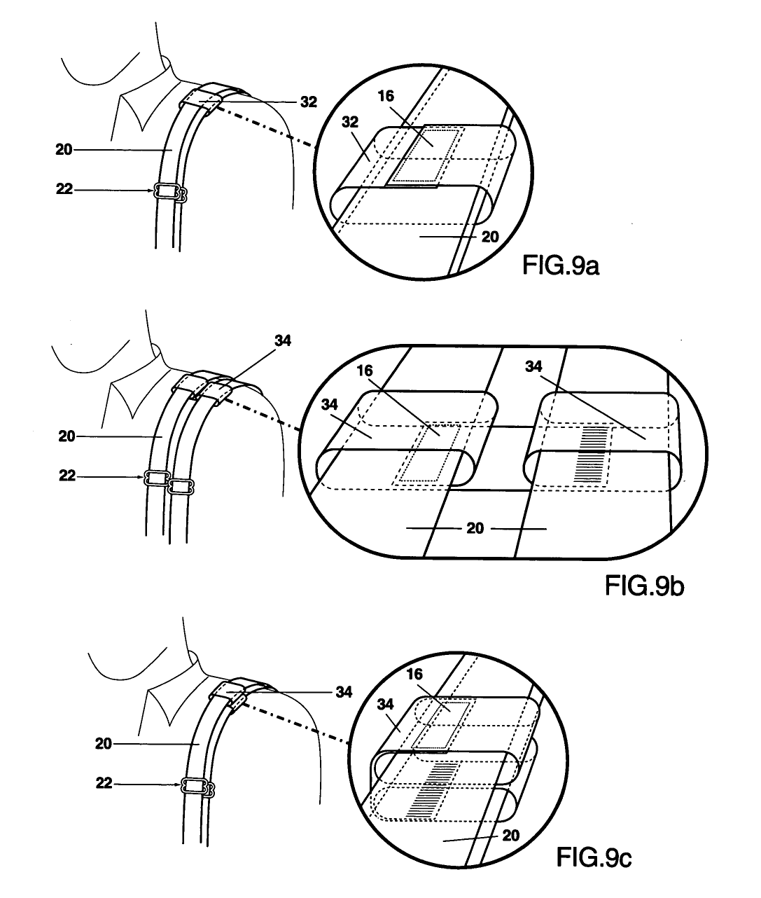

FIG. 9a-9c Additional Shoulder Strap Coupling Band Embodiment

Illustrated in FIG. 9a-9c is the construction and usage of a strap coupling band 32 that is made of a semi-rigid, flexible, flat, not round, binding material 28 or any other comparably flexible semi-rigid material. Coupling band 32 shown in FIG. 9a is formed of sufficient length to wrap the band around the adjustable carrier straps 20 and joined to itself by use of a hook and loop joinder 16. The human handler would position the coupling band 32 simultaneously around both carry straps 20 with the band joined together with the hook and loop strips 16. This allows the pet to be carried over the shoulder without the two straps separating while being worn or one strap dislodging, slipping, or twisting from its position on the human handler's shoulder. A padding material could be applied to that portion of the coupling band 32 that would remain subordinate to the carrying straps 20 on the superior side of the loop 32.

FIG. 9 also reveals a secondary configuration of a coupling band 34 in two separate positions: an open position in FIG. 9b as initially assembled by the handler and a stacked position in FIG. 9c as worn by a human carrier. This coupling band prevents the straps from separating while being worn and from twisting, or sliding off the shoulder of the human. It has an added feature that, when the carrier is opened and the two carry straps 20 become separated, the coupling loop 34 remains attached to one of the straps preventing its being lost or misplaced. This second coupling band configuration allows the carrier to be opened while still on the human's shoulder through the easy release of the hook and loop strips 16.

The coupling band 34 is also made of a semi-rigid, flexible flat, non-round binding material and is assembled with one loop of the band that would wrap around the adjustable carrier strap 20 be permanently joined to itself by a permanent, non-releasable fastening method such as stitching. The coupling material would then continue past the permanent joinder to form a loop around the second adjustable carrier strap 20 and rejoin to itself to conclude the coupling by means of hook and loop strips 16. The human carrier would insert and pass a removable adjustable carry strap 20 through the permanently affixed loop of the coupling band 34, with the other carry strap 20 passed through the loop of the coupling band that is closed by hook and loop fastener, as shown in FIG. 9b. The two carry straps 20 can then be stacked for wearing, as shown in the stacked position of FIG. 9c.

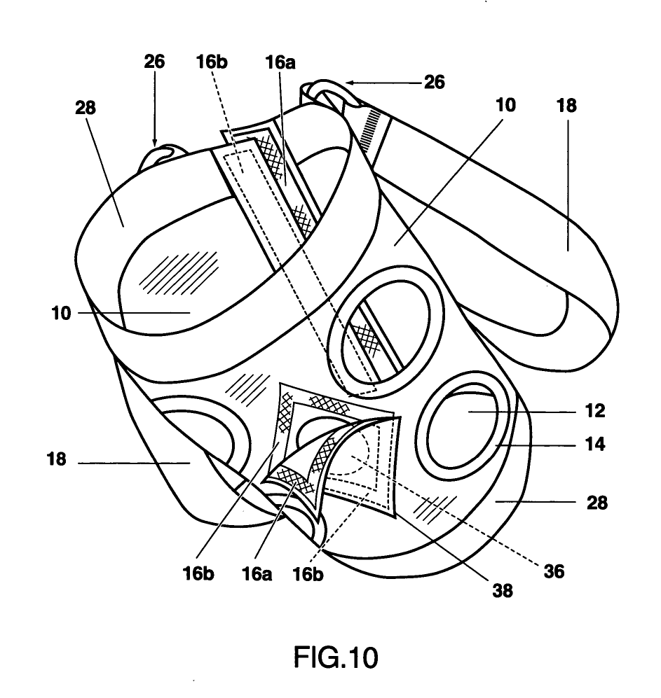

FIG. 10a-10b Additional Urinary Needs Embodiment

An alternate embodiment is shown in FIG. 10, that employs an opening 36 that has a closing cover 38 that attaches to the body panel 10 at a location positioned under the abdomen with the opening of sufficient size to accommodate the pet- occupant's urinary needs while still retained in the carrier. The edges of the opening 36 would be tucked under and fastened to itself by a fastening means such that there would be no raw edges. The cover 38 is made of the same material as body panel 10 and larger than the opening 36 of sufficient size to adequately cover the same.

The cover 38 on its inferior “unfinished” side would be lined at its perimeter with a strip of hook 16a and affixed by suitable fastening methods to leave no raw edges. Similarly, the superior side body panel 10 would have a strip of loop 16b affixed by a fastening means such that the dimensions of the hook on cover 38 would be identical to the loop on the body panel 10 for their proper joinder.

The normal operation of this embodiment would call for the hook and loop 16 to be joined so that the cover 38 conceals the opening 36 on the underside of the carrier while being easily removed for the animal to evacuate without being removed from the carrier. Upon completion of the animal's evacuation, the cover 38 would be replaced by the reconnection of the hook and loop strips 16.

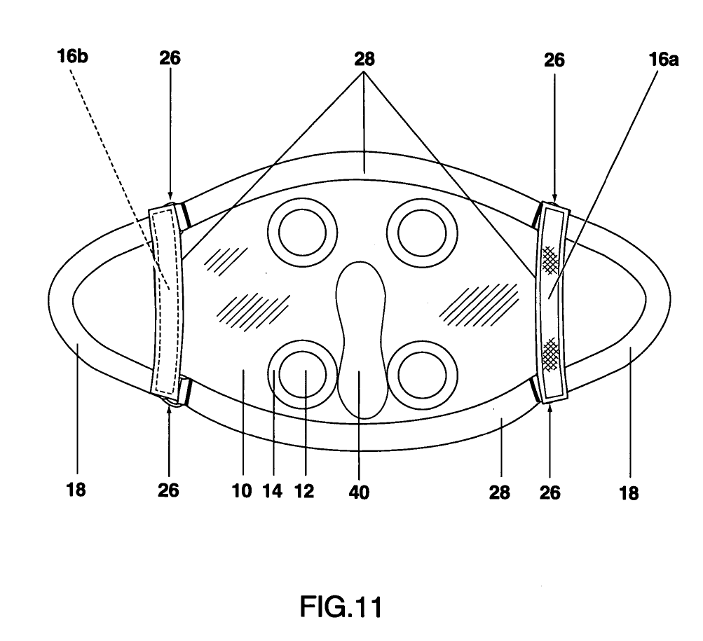

FIG. 11 Additional Incontinent Pad Embodiment

Senior and very young pet-occupants will find useful the embodiment of the carrier illustrated in FIG. 11 that employs a disposable incontinent pad 40. Disposable incontinent pads 40 are readily available at local pharmacies and can be affixed to body panel 10 by the self-adhesive strip that is included on the pad at a location between the two rear leg openings along the centerline of the body panel 10. This embodiment and usage allows both a senior pet and a young animal with unrestrained bladders to enjoy the use of the carrier.

Additional Medical Usage Embodiments

The carrier apparatus is also capable of being employed in the medical veterinary field in two primary manners. First, the carrier in an open non-closed form similar to FIG. 3, can function as a stretcher using the longer edge semi-rigid binding material 28 to provide support and facilitate transport of an injured animal from one place to another by two veterinary technicians each holding one tote handle 18 as the animal is draped with its head at one of the longer edges of the carrier and his tail end at the other. The carrier, when employed for this purpose, can be fabricated with or without hook and loop strips 16, and with the body panel 10 made of materials that are washable, able to be disinfected, or are disposable after each use

The second medical adaptation of the carrier is as an efficient means of transporting an animal after surgical procedures. The carrier provides protection for the animal and allows the human handler a higher degree of comfort and stability in transport of the occupant from hospital to home, thus enhancing the recovery process and the well being of the human handler. These medical carriers would employ the same hook and loop strips 16 as in the preferred embodiment and also be made of washable materials.

Additional Seat Belt Embodiment

The carrier apparatus can also be utilized to restrain the pet while being transported in a motor vehicle to prevent pet injury due to striking a dashboard or other interior portions of a vehicle during a sudden stop. This is accomplished by inserting the seatbelt of the vehicle through the affixed tote style handles of the occupied pet carrier and buckling in the seat belt to the vehicle seatbelt receptacle.

Additional Pocket and Pouch Embodiments

Other embodiments are also available to enhance the uses of the pet carrier transportation system. For example, a piece of fabric matching or contrasting with body panel 10 can be attached onto body panel as a pouch or pocket allowing the human carrier a storage place. This pouch or pocket may or may not have a top flap to enclose it closed by hook and loop strips or other securement means.

In addition, this embodiment would include placement of pockets/pouches on the strap 20 rather than the panel 10 for use in carrying items such as keys, cell phones, cameras, keys, money, dog treats, dog leash and waste bags. These holders can be fashioned by a strip of binding material that is stitched at a 90° angle to the length of the strap 20 such that either end of the strip can be employed as the top or bottom of the holder. This in turn allows the apparatus to be worn in the front or the back of the human torso, as the human or pet's comfort dictates.

Advantages

From the description above, a number of advantages of the subject carrier system become evident:
(a) This apparatus allows the pet to be transported in an open-air more natural horizontal level orientation lessening spinal stress and provides for a convex shaped body panel encased at its perimeter with flexible, semi-rigid binding material that supports the weight of the pet beneath the chest area lessening the possibility of chocking hazards and has cushioned, moldable leg openings for the pet's comfort.
(b) This apparel-like apparatus is also wearable by the human handler and is multi-positional by use of an adjustable strap system that easily adapts to the numerous activities the handler may wish to share with the pet and enables the handler to use both hands when engaging in those activities.
(c) The open-air nature of the device promotes a reduction in the anxiety pets experience when being transported in enclosed carriers while also avoiding health problems caused by excessive heat buildup.
(d) The apparatus allows the modern multi-tasking individual to be with their pet and use both hands when participating in various activities and on various terrains.
(e) The pet is now in close proximity to its handler and the weight of the pet is near the human's body thereby reducing the strain otherwise incurred by attempting to carry the pet's weight away from the human torso.
(f) This apparatus employs an overlapping fastening means of a hook and loop system in one continuous line-down-the-spine of the animal in conjunction with a “locking” configuration where each pair of swivel hooks at the strap ends are attached to both D-rings at the front and rear openings of the carrier.

### CONCLUSIONS, RAMIFICATIONS, AND SCOPE OF INVENTION

Accordingly, the reader will see that the proposed invention provides for an improved pet carry system that is readily adaptable by a user to transport the animal off ground in numerous ways while maintaining the comfort and safety of both pet and human companion.
it permits the pet to be carried, stand, sit or lie down; to be exercised, petted, walked, cradled, cuddled, examined, or fed; all while being retained within the carrier.
it permits the pet to be in close body contact with the human handler who can experience a high degree of physical comfort and versatility in carriage.
it permits the human to have peace of mind in the knowledge that their pet is by their side, visible, in air-cooled comfort and touchable, without barriers and safely out of harm's way.
it permits the human handler to dine at a restaurant with the pet in the device by the human's side, resting in the human's lap, cradled in the human's arms or securely seated at the human's feet without ever removing the pet from this apparel-type apparatus.
it permits the human to use two free hands to shop, dine, conduct business, operate a vehicle (while the device and pet-occupant are seat-belted) or carry groceries.
it allows the human to undertake long walks in the course of a busy day even over rough terrain or engage in a daily exercise routine which they were previously prevented from doing with short-legged pets that usually cannot maintain sufficient speed or duration of walk time to satisfy the human.

Although the above-noted description contains many specificities, these should be considered illustrative only of the basic principles of the invention and since modifications or changes can be made by anyone reasonably skilled in the art, the invention should not be limited to the exact construction, operation, usage, material, or dimensions shown or discussed. Many other variations are possible.

For example: although not a preferred method, it is anticipated that hard or solid style tote handles can be employed rather than flexible material style handles and could be comprised of numerous substances. The handles could have any desired shape so long as the ends of each handle could join the connector means at the shorter edge side of the body panel. Furthermore, it is also anticipated that the device can be accessorized by optional ornamental embellishments about the carrier.

Therefore, the scope of the invention should be determined by the appended claims and their legal equivalents, and not by the examples given, and all suitable modifications may be resorted to, falling within the scope of the invention.

1. A wearable apparatus and method for transporting and carrying an animal off ground, the apparatus comprising:
(a) a sheet of material defining a body panel that is substantially convex in shape defining one pair of edges of equal length that are shorter than a second pair of equal length edges to pass beneath and be drawn up around the animal,
(b) said body panel having four (4) openings of predetermined equal diameter through which the legs of the animal are inserted and hang freely, and
(c) a plurality of semi-rigid binding material of predetermined length and thickness lining the inferior and superior perimeter of said body panel and a means for joining said binding material to the body panel, and
(d) a releasable fastening means for joining together the shorter edge sides of said body panel around the animal at and in line with its spine forming a substantially tubular shape defining a front and rear opening,
(e) said releasable fastening means to be attached to join the superior aspect of one shorter edge side with the inferior aspect of the other shorter edge side, and
(f) said body panel defining an opening at the front of said tubular shape from which the head and chest of the animal extend and an opening at the rear portion from which the hindquarters and tail of the animal extend, and
(g) a pair of connecting means secured to each end of the binding material at the superior aspect of said body panel at the front and rear openings of said tubular shape, and
(h) a pair of handle means of predetermined length attached to said connecting means in line with said releasable fastening means from the front opening to rear opening of said tubular shape to support and carry the weight of the animal,
wherein the animal is securely retained for transport within the body panel in a natural horizontal level orientation neutralizing spinal stress and with its legs extended below the carrier approximately equidistant from the ground.

2. The apparatus according to claim 1, further comprising,
(a) a pair of strap means of semi-rigid material and predetermined length, width and thickness, and
(b) a releasable securement means attached to the ends of each strap means, and
(c) said releasable securement means attached to the connecting means at the front and rear portions of said tubular container to support and carry the weight of the animal, and
(d) a means for selectively adjusting the total connected length of each said strap means,
wherein the animal is retained within the main body panel for transport by said strap means and adjustable in elevation in relation to the height and body style of the handler.

3. The apparatus according to claim 1, further comprising,
(a) a flexible material secured to the circumference of said four (4) leg openings and a means for attaching same at the inferior and superior aspect of the body panel, and
(b) said flexible material having been cut on the bias, and
(c) a portion of said flexible material extending not less than approximately one-quarter inch (¼″) inwards towards the center point of each leg opening, and
(d) said leg openings incrementally increasing and decreasing in diameter and distance between the center points of each leg opening for differing animal breeds and sizes, whereby said leg openings are cushioned and conform to the legs of different animal breeds and sizes.

4. The apparatus according to claim 1 wherein
(a) said body panel being formed into said tubular shape defining an arc formed by the front opening of the tubular shape passing beneath the animal at the chest area in front of the forelegs, and
(b) said body panel being formed into said tubular shape defining a second arc formed by the rear opening of the tubular shape passing beneath the animal directly under the hindquarters,
whereby the animal is securely retained within the carrier with the apparatus contacting the animal at its underside from the chest area through to the hindquarters.
arcing manner opposite to one another

5. The apparatus according to claim 4, wherein,
(a) said body panel defining a distance at the widest point between the arcs formed by the front and rear opening as being approximately one-third (⅓) longer than the length of a shorter edge side, and
(b) said body panel defining a length of a shorter edge side as being approximately one-half (½) the distance between said pair of shorter edges, and
(c) said body panel incrementally increasing and decreasing in overall size by retaining the above relative length and distance ratios,
whereby the carrier is substantially convex in shape contacting the underside of the animal from chest area through to the hindquarters and differing in overall size to retain animals of different breeds and body sizes.

6. The apparatus according to claim 5, wherein
(a) said body panel defining a predetermined length for the binding material of the longer edge side at said tubular shape front opening that is greater than the predetermined length of the opposite longer edge side at the rear opening, and
(b) said body panel at both shorter edges remaining equal in length,
whereby the opening for the head and chest of the animal at the front of the tubular shape will be larger than the opening at the rear of the tubular shape to retain animals that have more girth from the mid-body forward than from waist to hindquarters.

7. The apparatus according to claim 4 wherein
said convex shape of the body panel positions the forward weight at, on, or near the chest area of the pet,
whereby contact with the esophageal neck area of an animal is avoided reducing choking, asphyxiation or strangulation hazards.

8. The apparatus according to claim 1, further comprising
said body panel made of flexible lightweight body-conforming material contouring to the shape of the animal and body of the handler,
wherein the apparatus may be worn in close proximity to the body of the handler.

9. The apparatus according to claim 1, wherein
(a) said connecting means in line with the releasable fastening means at the front opening of the tubular shape include a pair of rings, and
(b) said connecting means in line with the releasable fastening means at the rear opening of the tubular shape include a pair of rings, and
(c) said releasable securement means at the ends of all said strap means connect to said front and rear ring pairs, and
(d) said handle means connect to said front and rear ring pairs.

10. The apparatus according to claim 2, further comprising,
(a) said strap means being multi-positional and secured to said pair of connecting means at the front and rear openings of the tubular shape to form straps to support and carry the weight of the animal on the shoulder of the handler, cross-chest to opposite hip of the handler, and around the circumference of the waist of the handler, and
(b) said strap means being multi-positional and secured to both of said pair of connecting means at the front opening of the tubular shape and released from the pair at the rear opening connecting means to form a leash to restrain the animal when the animal is walking on the ground, and
(c) said strap means being multi-positional and secured to both of said pair of connecting means at the front opening of the tubular shape and both of said pair of connecting means at the rear opening to securely lock the pet into the carrier in the event of an unintentional disengagement of the releasable fastening means,
whereby the carrier is readily maneuverable, convertible and permits the handler to maintain the animal in a horizontal level orientation relative to the ground during different usage.

11. The apparatus according to claim 2, wherein
said releasable securement means at the ends of the respective strap means comprises a member selected from the group consisting of: swivel hooks, snap hooks, buckles, and four-part connectors.

12. The apparatus according to claim 2, wherein
(a) said means for selectively adjusting the total connected length of said strap means includes a tri-glide slide, and
(b) said tri-glide slide adjusts the strap means to configure the elevation of the apparatus relative to the ground,
whereby the apparatus is adjustable for the height and body style of the handler relative to the ground.

13. The apparatus according to claim 2, wherein
said semi-rigid material of the strap means comprises a material selected from the group consisting of: polypropylene webbing, nylon webbing, leather strapping, synthetic fiber strapping, natural fiber strapping, chain, braided fabric, and plastic strapping.

14. The apparatus according to claim 1, wherein
said releasable fastening means for joining the opposite shorter edges of said body panel together comprises a member selected from the group consisting of: a hook and loop fastening system, a zipper, a button and snap system, a four part snap set, a rivet, a post and screw set, a drawstring, a hook and eye system.

15. The apparatus according to claim 1, wherein
said binding material comprises a material selected from the group consisting of: polypropylene webbing, nylon webbing, leather, synthetic fiber, and natural fiber.

16. An apparatus and method for transporting and carrying an animal off ground, the method comprising:
(a) providing an apparatus to transport and carry an animal comprising:
(i) a sheet of flexible material defining a body panel of a first pair of edges of predetermined length and a second pair of edges longer than the first pair and substantially convex in shape having four (4) leg openings of equal diameter, and
(ii) a releasable fastening means for joining together the shorter edges of said body panel around the animal in line with its spine, and
(iii) a pair of connecting means attached to said body panel, and
(iv) a handle means attached to the connecting means of said body panel, and
(v) a pair of adjustable strap means attached to the connecting means of said body panel by a releasable securement means,
(b) securing the animal within said apparatus,
(c) releasably fastening the apparatus around the animal,
(d) securing the strap means to the apparatus,
(e) securing the apparatus to a person,
(f) carrying and transporting the animal within the apparatus.

17. A method for transporting and carrying an animal of claim 16, wherein a person transports the animal and apparatus by said handle means.

18. A method for transporting and carrying an animal of claim 16, further comprising providing a body panel made of lightweight flexible body-conforming material which allows the apparatus to be worn in close proximity to the body of the person.

19. A method for transporting and carrying an animal of claim 16, further comprising a multi-positional adjustable strap means positioning the apparatus over the persons shoulder, across the chest, around the waist for transporting the animal and apparatus, and converted into a leash for restraining the animal within the apparatus while walking.

20. A method for transporting and carrying an animal of claim 16, further comprising one adjustable strap means positioning the releasable securement means on one pair of connecting means of said body panel, and the second adjustable strap means positioning the releasable securement means on the second pair of connecting means of said body panel locking the apparatus closed around the animal while in transport.
